(19) United States
(12) Patent Application Publication
(10) Pub. No.: US 2006/0068831 A1
(43) Pub. Date: Mar. 30, 2006

(54) Predictive power control in a digital diversity receiver

(76) Inventors: Kenneth A. Stewart, Grayslake, IL (US); Christopher N. Kurby, Elmhurst, IL (US)

Correspondence Address: MOTOROLA INC, 600 NORTH US HIGHWAY 45, ROOM AS437, LIBERTYVILLE, IL, 60048-5343, US

(21) Appl. No.: 10/955,382

(22) Filed: Sep. 30, 2004

(51) Int. Cl. H04Q 7/20

(52) U.S. Cl. 455/522

(57) ABSTRACT

A method (300) and an apparatus (202) for a digital diversity receiver having a first receiver branch (204) and a second receiver branch (206) for adjusting a receiver power control loop during a radio frame (100) of a known length are provide. The digital diversity receiver (202) receives a first signal (208) through the first receiver branch (204) during the radio frame (100), and receives a second signal (210) through the second receiver branch (206) during a portion of the radio frame (106, 110). The second signal (210) originates from a common original signal (212) as the first signal 208. The digital diversity receiver (202) evaluates (308) a receiver power control parameter for the first interval (106) based upon the first signal (208) and the second signal (210), and compensates (310) the receiver power control parameter with an offset value for the first interval (106). The compensated receiver power control parameter is then applied (312) to the receiver power control loop during the first interval.

### FIELD OF THE INVENTION

The present invention generally relates to a power control mechanism for a communication device, and more specifically to a receiver power control mechanism in a communication device having a receive diversity capability.

### BACKGROUND OF THE INVENTION

Universal Mobile Telecommunications System-Frequency Division Duplex (“UMTS-FDD”) networks, such as Wideband Code Division Multiple Access (“WCDMA”) networks, use measurement intervals, usually in combination with compressed mode (“CM”), to permit a User Equipment (“UE”) such as a cellular mobile device to perform inter-frequency measurements on other UMTS cells, or on cells deployed using other supported Radio Access Technologies (“RAT's”), such as, but not limited to, Global System for Mobile Communications (“GSM”), General Packet Radio Service (“GPRS”) and Enhanced Data-rates for GSM Evolution (“EDGE”). By using a symbol puncturing or spreading factor reduction method, multiple vacant downlink timeslots are created either: a) in the approximate center of a 10 millisecond (“msec”) radio frame; or b) overlapping two adjacent 10 msec radio frames. FIG. 1 illustrates an exemplary downlink radio frame 100 having a known length, which has a frame start 102 and a frame end 104, segmented into three intervals: the first interval 106; second interval 108, which is also referred to as a transmission gap; and the third interval 110. The transmission gap 108 starts from a gap start 112, which is also the end of the first interval 106, and ends at a gap end 114, which is also the beginning of the third interval 110. Although the UE is not capable of simultaneously monitoring two frequencies, during the transmission gap 104, the UE is able to change the frequency, and perform necessary inter-frequency measurements, and optionally inter-RAT measurements.

In UMTS-FDD architectures supporting a receive diversity capability having a main receiver branch and a diversity receiver branch, it can be less costly to dedicate the main receive branch to UMTS-FDD and to permit the diversity receiver branch to be adaptable to either GSM or UMTS-FDD. This two-branch receiver approach provides reduced cost compared to, for example, a three-branch receiver system with two branches dedicated to UMTS-FDD and a third single branch dedicated to GSM. However, in the two-branch receiver, the UMTS-FDD signal in the diversity receiver branch is lost at the onset of an inter-frequency or inter-RAT measurement opportunity at the gap start 112 when the diversity receiver branch is switched to measure the GSM signal. This loss of the diversity receiver branch forces the two-branch receiver to revert to a single branch, or single antenna, using only the main receiver branch for the UMTS-FDD signal. When operating within a closed-loop power control scheme, such as in UMTS-FDD, however, this loss of the diversity receiver branch can be problematic. Because a signal-to-noise-ratio (“SNR”) of an observed signal at an output of a diversity combiner will experience an instantaneous loss of the SNR due to the loss of the diversity receiver branch, the quality of the soft decisions, such as log-likelihood ratios (“LLR's”), of the associated encoded symbol will be reduced and the probability of erasing the associated transmission time interval (TTI) frame will also be increased. For example, if an instantaneous channel impulse response observed at each antenna produces an SNR of a, which is identical for each antenna, the SNR at the diversity combiner output would be 2a just prior to the gap start 112 of the transmission gap 108, and then would immediately fall by 3 dB to a after the diversity receiver branch is removed at the gap start 112. If the main receiver branch had a lower SNR than the diversity receiver branch, then the reduction in SNR upon the loss of diversity branch signal input would be even greater.

### BRIEF DESCRIPTION OF THE DRAWINGS

FIG. 1 is an exemplary downlink radio frame having a transmission gap comprising seven consecutive slots suspended in the center of the downlink radio frame.

FIG. 2 illustrates an exemplary environment in which a digital diversity receiver in accordance with at least one of the preferred embodiments may be practiced;

FIG. 3 is an exemplary flowchart for adjusting a receiver power control loop in the digital diversity receiver during a radio frame in accordance with at least one of the preferred embodiments; and

FIG. 4 is an exemplary block diagram of a wireless communication device having a digital diversity receiver in accordance with at least one of the preferred embodiments.

### DETAILED DESCRIPTION OF THE PREFERRED EMBODIMENTS

A digital diversity receiver, which is equipped with a first receiver branch and a second receiver branch, receives a first signal, which is a first version of a common original signal, in the first receiver branch and a second signal, which is a second version of the common original signal, in the second receiver branch during a radio frame. The radio frame may a data frame of a known data length or a time frame of a known time duration, and may comprise of a plurality of sub-frames. The radio frame is segmented into first, second, and third intervals, and the first receiver branch receives the first signal in all intervals. The second receiver branch, however, receives the second signal only during the first and third intervals, and receives a third signal, which is not related to the common original signal, during the second interval. The third signal may originate from a nearby base station compatible with the digital diversity receiver. During the first and third intervals, both the first and second signal are used to evaluate received signal parameters for the common original signal such as a receiver power control parameter and symbol log-likelihood ratios. Because during the second interval, the second receiver branch receives the third signal, which is unrelated to the common original signal, only the first signal is used to evaluate the received signal parameters for the common original signal. To avoid a sudden change in the signal parameters due to the absence of the second signal at the beginning of the second interval, the receiver power control parameter during the first interval is compensated.

FIG. 2 illustrates an exemplary environment 200 in which a digital diversity receiver 202 in accordance with at least one of the preferred embodiments may be practiced. The digital diversity receiver 202 has a first receiver branch 204 and a second receiver branch 206. The first receiver branch 204 receives a first signal 208 during the entire radio frame 100, and the second branch 206 receives a second signal 210 during the first interval 106 and third interval 110. The first signal 208 and the second signal 210 are different versions of a common original signal 212 originating from a common base station 214, but are independently faded, respectively arriving at the first receiver branch 204 and the second receiver branch 206 after taking independent paths. The first signal 208 and the second signal 210 may also be correlated to each other based upon other characteristics such as their time of transmission and their signal frequencies. During the second interval 108, the second receiver branch 206 receives a third signal 216, which is not related to the common original signal 212. The third signal 216 in this example is shown to originate from a separate base station 218, however, the third signal 216 may be also be transmitted from the common base station 214 at a different signal frequency from the first signal 208 and the second signal 210.

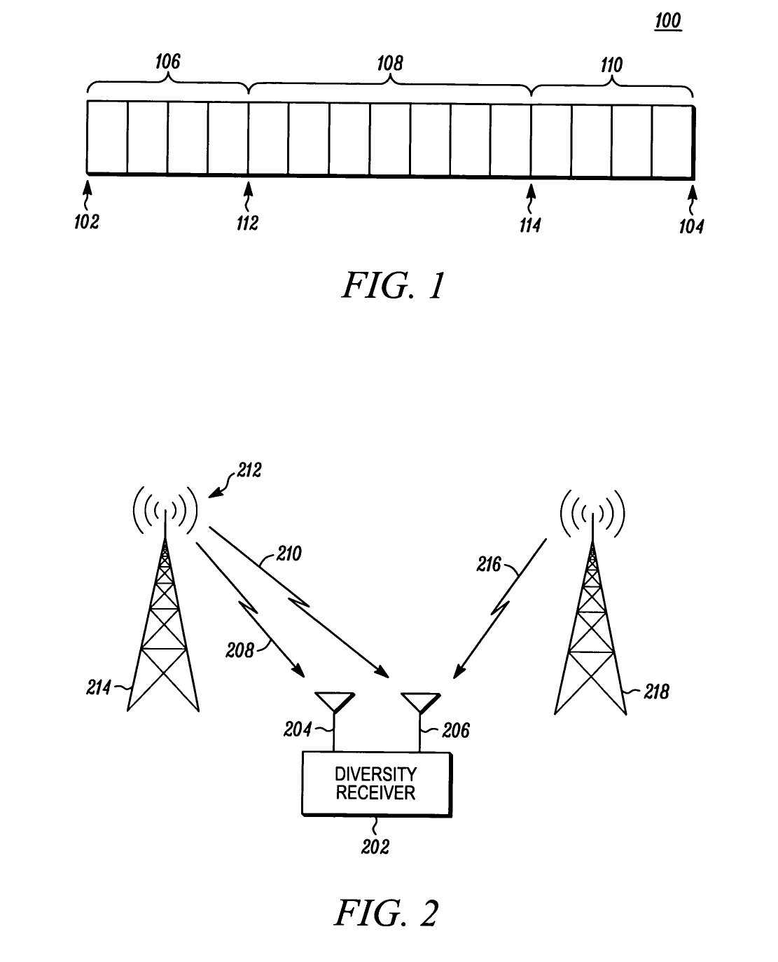

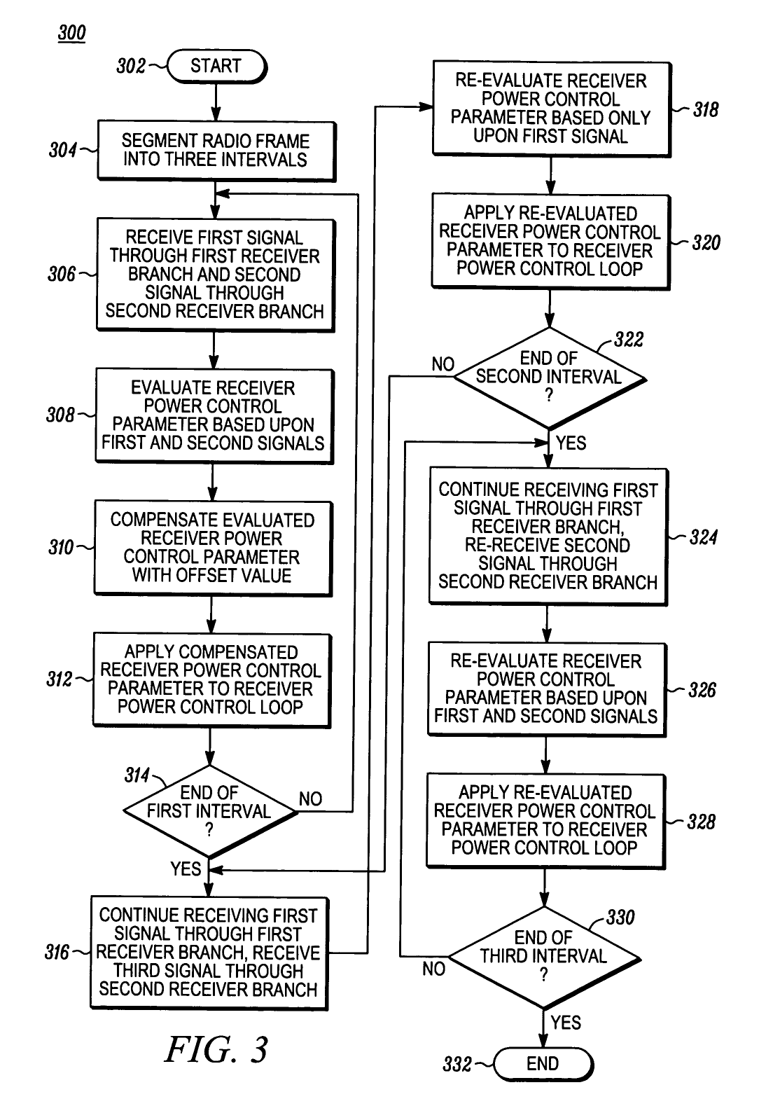

FIG. 3 illustrates an exemplary flowchart 300 for adjusting a receiver power control loop in the digital diversity receiver 202 in accordance with at least one of the preferred embodiments. The process begins in block 302, and the radio frame 100, which has a known duration and a known number of time slots, is segmented into three consecutive intervals: first interval 106, second interval 108, and third interval 10 in block 304 as previously shown in FIG. 1, such that an appropriate routine can be applied for each interval. In block 306, for the first interval 106, the first receiver branch 204 receives the first signal 208 and the second receiver branch 206 receives the second signal 210. As previously described, the first signal 208 and the second signal 210 are different versions of a common original signal 212 originating from a common base station 214, but are independently faded, respectively arriving at the first receiver branch 204 and the second receiver branch 206 after taking independent paths. The first signal 208 and the second signal 210 may also be correlated to each other based upon other characteristics such as their time of transmission and their signal frequencies. In block 308, a receiver power control parameter is evaluated based upon the first and second signals 208 and 210. Symbol log-likelihood ratios (“LLRs”) of the common original signal 212 may also be evaluated in block 308 based upon the first signal 208 and the second signal 210 for the first interval 106. Because the second signal 210 is known to become unavailable in the second interval 108, the receiver power control parameter may alternatively be evaluated based only upon the first signal 208 in the first interval 106 or in the period prior to and including the first interval 106. The digital diversity receiver 202 may then request an increase in the transmitted power of the common original signal 212 to compensate for the unavailability of the second signal 210. Further, because the second signal 210 is known to become unavailable in the second interval 108, the digital diversity receiver 202 may simply request an increase in the transmitted power of the common original signal 212 during the first interval 106 or during the period prior to and including the first interval 106. In block 310, the evaluated receiver power control parameter is compensated with an offset value, and in block 312, the compensated receiver power control parameter is applied to the receiver power control loop. The offset value may be a constant value or a time varying value such as a ramp function linearly increasing from zero at the beginning of the first interval 106 to a predetermined value at the end of the first interval 106. The compensated receiver power control parameter may then be compared against a target receiver power control parameter, and a request to change the transmitted power of the common original signal 212 may be made based upon the comparison.

In block 314, whether the end of the first interval 106 has been reached is checked. If the end of the first interval 106 has not been reached, the process returns to block 308. If the end of the first interval 106 has been reached, then for the second interval 108, the first receiver branch 204 continues to receive the first signal 208 and the second receiver branch 206 receives the third signal 216 in block 316. In block 318, the receiver power control parameter is re-evaluated based only upon the first signal 208, and the symbol LLRs of the common original signal 212 may also be re-evaluated based only upon the first signal 208 for the second interval 108. The re-evaluated receiver power control parameter is applied to the receiver power control loop in block 320, which may include requesting an increase in the transmitted power of the common original signal 212 to compensate for the loss of the second signal 210. The offset value and the requested increase in the transmitted power of the common original signal 212 may be calculated based upon a comparison between the evaluated receiver power control parameter of block 308, which is based upon the first signal 208 and the second signal 210, and the re-evaluated power control parameter of block 318, which is based only upon the first signal 208.

In block 322, whether the end of the second interval 108 has been reached is checked. If the end of the second interval 108 has not been reached, the process returns to block 316. If the end of the second interval 108 has been reached, then for the third interval 110, the first receiver branch 204 continues to receive the first signal 208 and the second receiver branch 206 again receives the second signal 210 in block 324. Based upon the first and second signals, the receiver power control parameter is re-evaluated in block 326, and the re-evaluated receiver power control parameter is applied to the receiver power control loop in block 328, which may include comparing the re-evaluated receiver power control parameter against the target power control parameter, and requesting a change in the transmitted power of the common original signal 212 based upon the comparison. In block 330, whether the end of the third interval 10 has been reached is checked. If the end of the third interval 110 has not been reached, the process returns to block 324. If the end of the third interval 110 has been reached, then the process terminates in block 326. Alternatively, the process 10 may loop back to block 306 for the next radio frame.

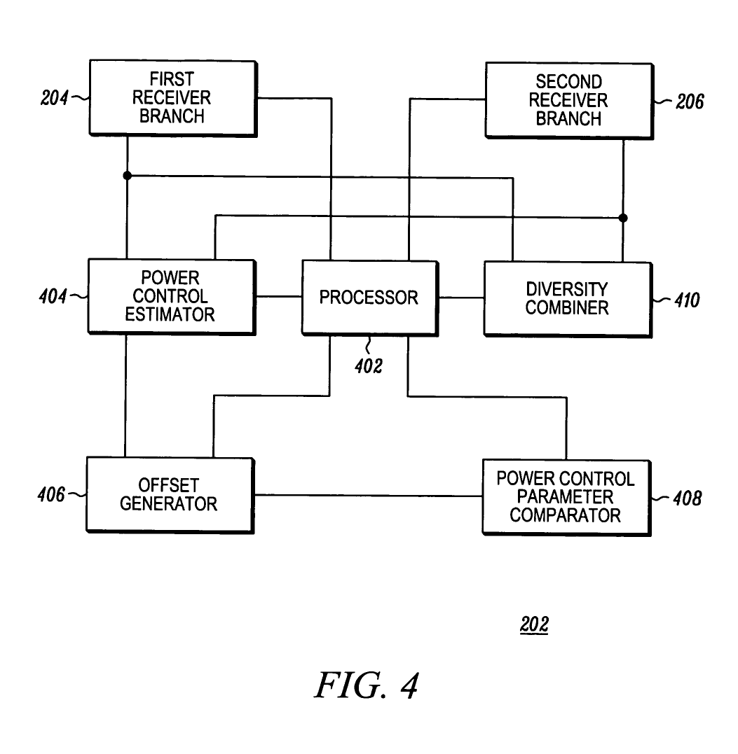

FIG. 4 is an exemplary block diagram of the digital diversity receiver 202 in accordance with at least one of the preferred embodiments. The digital diversity receiver 202 comprises a processor 402, which is configured to segment the radio frame 100 of a known length into the first interval 106, the second interval 108, and the third interval 110, and is coupled to the first receiver branch 204 and to the second receiver branch 206. The first receiver branch 204 is configured to receive the first signal 208 for the entire radio frame 100, and the second receiver branch 206 is configured to receive the second signal 210 for the first interval 106 and the third interval 110. As previously described, the first signal 208 and the second signal 210 are different versions of the common original signal 212 originating from the common base station 214, but are independently faded, respectively arriving at the first receiver branch 204 and the second receiver branch 206 after taking independent paths. The first signal 208 and the second signal 210 may also be correlated to each other based upon other characteristics such as their time of transmission and their signal frequencies. A power control estimator 404 is coupled to the processor 402 and to both of the first receiver branch 204 and the second receiver branch 206, and is configured to generate an estimate power control parameter. The processor 402 is further configured to direct the power control estimator 404 to generate the estimate power control parameter based upon the first signal 208 and the second signal 210 for the first interval 106, based upon the first signal 208 only for the second interval 108, and based upon the first signal 208 and the second signal 210 for the third interval 110. Because the second signal 210 is known to become unavailable in the second interval 108, the processor 402 may be alternatively configured to direct the power control estimator 404 to generate the estimate power control parameter based only upon the first signal 208 in the first interval 106 or in the period prior to and including the first interval 106. An offset generator 406 is coupled to the processor 402 and to the power control estimator 404, and is configured to generate an offset value and to generate an offset power control parameter based upon the estimate power control parameter and the offset value. The offset value may be a constant value or a time varying value such as a ramp function linearly increasing from zero at the beginning of the first interval 106 to a predetermined value at the end of the first interval 106. The processor 402 may be further configured to direct the offset generator 406 to generate the offset value based upon a difference between the estimate power control parameter for the first interval 106 and the estimate power control parameter for the second interval. A power control parameter comparator 408 is coupled to the processor 402 and the offset generator 406, and is configured to compare the offset power control parameter from the offset generator 406 and a target power control parameter for the first interval 106 and the third interval 110. The processor 402 is further configured to direct the power control parameter comparator 408 to generate a request to vary a transmitted power of the common original signal 212 based upon the first signal 208 and the second signal 210 for the first interval 106 and the third interval 110, and to increase the transmitted power of the common original signal 212 for the second interval 110. Further, because the second signal 210 is known to become unavailable in the second interval 108, the processor 402 may be simply configured to direct the power control parameter comparator 408 to generate a request to increase the transmitted power of the common original signal 212 during the first interval 106 or during the period prior to and including the first interval 106. The digital diversity receiver 202 further includes a diversity combiner 410, which is coupled to the processor 402 and both of the first receiver branch 204 and the second receiver branch 206. The diversity combiner 410 is configured to generate a symbol log-likelihood ratio of the common original signal 212 for the first interval 106 and the third interval 110 based upon both of the first signal 208 and the second signal 210. For the second interval 108, the diversity combiner 410 is configured to generate the symbol log-likelihood ratio of the common original signal 212 based upon first signal 208.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method in a digital diversity receiver having a first receiver branch and a second receiver branch for adjusting a receiver power control loop during a radio frame of a known length, the method comprising:
receiving a first signal through the first receiver branch during the radio frame,
receiving a second signal through the second receiver branch during a predetermined portion of the radio frame, the second signal originating from a common original signal as the first signal;
evaluating a receiver power control parameter for the predetermined portion of the radio frame based upon the first and second signals;
compensating the receiver power control parameter during the predetermined portion of the radio frame; and
applying the compensated receiver power control parameter to the receiver power control loop during the predetermined portion of the radio frame.

2. The method of claim 1, wherein the second signal originating from the common original signal as the first signal has at least one of:
a unique signal fading path, a unique time of transmission, and a unique signal frequency.

3. The method of claim 1, wherein evaluating a receiver power control parameter for the predetermined portion of the radio frame based upon the first and second signals includes:
disregarding at least one of the received first signal and the received second signal during the predetermined portion of the radio frame.

4. The method of claim 3, wherein compensating the receiver power control parameter during the predetermined portion of the radio frame includes requesting an increase in the transmitted power of the common original signal during the predetermined portion of the radio frame.

5. The method of claim 1, further comprising:
receiving a third signal through the second receiver branch during an interval in the radio frame after the portion of the radio frame;
re-evaluating the receiver power control parameter for the interval in the radio frame after the portion of the radio frame based upon the first signal; and
applying the re-evaluated receiver power control parameter to the receiver power control loop during the interval in the radio frame after the portion of the radio frame.

6. The method of claim 5, wherein compensating the receiver power control parameter during the predetermined portion of the radio frame includes compensating the receiver power control parameter with an offset value.

7. The method of claim 6, wherein the offset value is at least one of:
a constant value,
a time varying value over the predetermined portion of the radio frame, and
a calculated value based upon the evaluated receiver power control parameter for the predetermined portion of the radio frame and the re-evaluated receiver power control parameter for the interval in the radio frame after the portion of the radio frame.

8. The method of claim 5, further comprising:
evaluating a symbol log-likelihood ratio of the common original signal for the predetermined portion of the radio frame based upon the first and second signals; and
re-evaluating the symbol log-likelihood ratio of the common original signal for the interval in the radio frame after the predetermined portion of the radio frame based upon the first signal.

9. The method of claim 5, after the interval in the radio frame, further comprising:
re-receiving the second signal through the second receiver branch;
re-evaluating the receiver power control parameter based upon the first and second signals;
re-compensating the receiver power control parameter; and
applying the re-compensated receiver power control parameter to the receiver power control loop.

10. A method in a wireless portable communication device having digital diversity receiver for adjusting a receiver power control loop during a radio frame of a known length, the digital receiver having a first receiver branch and a second receiver branch, the method comprising:
segmenting the radio frame into first, second, and third intervals;
for the first interval,
receiving a first signal through the first receiver branch,
receiving a second signal through the second receiver branch, the second signal originating from a common original signal as the first signal;
evaluating a receiver power control parameter based upon the first and second signals;
compensating the receiver power control parameter with an offset value;
applying the compensated receiver power control parameter to the receiver power control loop;
for the second interval immediately following the first interval,
continuing receiving the first signal through the first receiver branch;
receiving a third signal through the second receiver branch;
re-evaluating the receiver power control parameter based upon the first signal;
applying the re-evaluated receiver power control parameter based upon the first signal to the receiver power control loop;
for the third interval immediately following the second interval,
continuing receiving the first signal through the first receiver branch;
re-receiving the second signal through the second receiver branch;
re-evaluating the receiver power control parameter based upon the first and second signals; and
applying the re-evaluated receiver power control parameter based upon the first and second signals to the receiver power control loop.

11. The method of claim 10, wherein the second signal originating from the common original signal as the first signal has at least one of:
a unique signal path,
a unique time of transmission, and
a unique signal frequency.

12. The method of claim 10, further comprising:
for the first interval,
evaluating a symbol log-likelihood ratio of a common original signal based upon the first and second signals;
for the second interval,
re-evaluating the symbol log-likelihood ratio of the common original signal based upon the first signal;
evaluating a symbol log-likelihood ratio of the third signal based upon the third signal; and
for the third interval,
re-evaluating the symbol log-likelihood ratio of the composite received signal based upon the first and second signals.

13. The method of claim 10, wherein evaluating a receiver power control parameter based upon the first and second signals for the first interval includes:
disregarding at least one of the received first signal and the received second signal during the first interval.

14. The method of claim 13, wherein compensating the receiver power control parameter with an offset value for the first interval includes:
requesting an increase in a transmitted power of the common original signal.

15. The method of claim 10, wherein the offset value is at least one of:
a constant value,
a time varying value over the first interval, and
a calculated value based upon the evaluated receiver power control parameter based upon the first and second signals in the first interval and the re-evaluated receiver power control parameter based upon the first signal in the second interval.

16. A digital diversity receiver comprising:
a processor configured to segment a radio frame of a known length into a first interval, a second interval, and a third interval;
a first receiver branch coupled to the processor, the first receiver branch configured to receive a first signal during the first, second, and third intervals of the radio frame;
a second receiver branch coupled to the processor, the second receiver branch configured to receive a second signal during the first intervals of the radio frame, the first and second signals originating from a common original signal;
a power control estimator coupled to the processor and to the first and receiver second receiver branches, the power control estimator configured to generate an estimate power control parameter;
an offset generator coupled to the processor and to the power control estimator, the offset generator configured to generate an offset value and an offset power control parameter, the offset power control parameter based upon the estimate power control parameter and the offset value;
a power control parameter comparator coupled to the processor and to the offset generator, the power control parameter comparator configured to compare the offset power control parameter and a target power control parameter; and
a diversity combiner coupled to the processor and to the first and second receiver branches, the diversity combiner configured to generate a log-likelihood ratio of the common transmitted signal based upon at least one of the first and second signals.

17. The digital diversity receiver of claim 16, wherein the processor is further configured to direct the power control estimator to generate the estimate power control parameter based upon the first and second signals for the first interval, based upon the first signal for the second interval, and based upon the first and second signals for the third interval.

18. The digital diversity receiver of claim 17, wherein the estimate power control parameter generated based upon the first and second signals for the first interval includes the estimate power control parameter generated based upon disregarding at least one of the first signal and the second signal.

19. The digital diversity receiver of claim 17, wherein the processor is further configured to direct the offset generator to generate the offset value as a constant value for the first interval.

20. The digital diversity receiver of claim 17, wherein the processor is further configured to direct the offset generator to generate the offset value as a time varying value over the first interval.

21. The digital diversity receiver of claim 17, wherein the processor is further configured to direct the offset generator to generate the offset value for the first interval based upon a comparison between the estimate power control parameter for the first interval and the estimate power control parameter for the second interval.

22. The digital diversity receiver of claim 17, wherein the processor is further configured to direct the diversity combiner to generate the log-likelihood ratio of the common original signal based upon the first and second signals for the first interval, based upon the first signal for the second interval, and based upon the first and second signals for the third interval.

23. The digital diversity receiver of claim 17, wherein the processor is further configured to direct the power control parameter comparator to generate a request to vary a transmitted power of the common original signal based upon the first and second signals for the first interval, to increase the transmitted power of the common original signal for the second interval, and to vary the transmitted power of the common original signal based upon the first and second signals for the third interval.
